(19) United States
(12) Patent Application Publication
(10) Pub. No.: US 2019/0338155 A1
(43) Pub. Date: Nov. 7, 2019

(54) PROCESS FOR FABRICATION OF PAINTS BASED ON EXPANDED POLYSTYRENE (EPS) WASTE

(71) Applicants: Cristina Lucía ACUÑA ROUGIER, Santiago (CL); Constanza Catalina de Lourdes CIFUENTES EAGLEHURST, Santiago (CL)

(72) Inventors: Cristina Lucía ACUÑA ROUGIER, Santiago (CL); Constanza Catalina de Lourdes CIFUENTES EAGLEHURST, Santiago (CL)

(21) Appl. No.: 16/348,404

(22) PCT Filed: Dec. 19, 2017
(86) PCT No.: PCT/IB2017/058127

§ 371 Date: May 8, 2019

(30) Foreign Application Priority Data
Jan. 4, 2017 (CL) 201700013

(51) Int. Cl. C09D 17/00; C09C 1/36; B29B 17/02

(52) U.S. Cl. CPC C09D 17/008; C09C 1/3607; B29K 2025/06; B29B 17/02; B29B 2017/0293; C09D 17/002

(57) ABSTRACT

The invention is related with the paint industry to use on surfaces of solid materials. The invention is a process to obtain paints using expanded polystyrene (EPS) waste as a raw material. From this technology we pursue to transform a waste into a useful product, saving resources and at the same time contributing to solve environmental contamination problems. This invention is composed by the following stages, a.-mixing the EPS waste with an organic solvent until reaching a concentration between 20% and 80% p/p; decanting impurities of the mixture obtained in stage (a) during 24 to 120 h; c.-collecting the supernatant obtained in stage (b); d.-dispersing a pigment in the supernatant obtained in stage (c) during 10 to 30 min at a velocity between 1.000 rpm and 2.000 rpm; e.-mixing the substance obtained in stage (d) with an organic solvent at a velocity between 300 rpm and 1.000 rpm until reaching the desired concentration. Additionally, the invention claims the formulation of a paint that is formed by 0% to 40% of pigment, 70% to 1% of EPS, 0.5% to 5.0% of dispersant, and the difference is solvent.

### FIELD OF THE INVENTION

The invention is related with the paint industry to use on surfaces. The invention is a process to obtain paints using expanded polystyrene (EPS) waste as a raw material. From this technology we pursue to transform a waste into a useful product, saving resources and at the same time contributing to solve environmental contamination problems.

### BACKGROUND OF THE INVENTION

EPS is an oil derived polymer with a number of applications in food, packing construction and other industries due to its economic advantages, low water absorption, harmlessness, inalterability and due to its inert nature. However, due to its fragility and low density, it generates large amounts of waste which has raised the concern of authorities, general population and complains of environmentalists. In Chile, 400.000 Kg of industrial EPS waste is generated each year, this does not include the household EPS waste which is disposed of at landfills, because processes to recycle it do not yet exist. Nowadays there are two options for final EPS waste disposition: one is to export it to China or Argentina where this waste is reused to obtain products like photo frames or school tools (http://www.mastropor.com.ar/reciclado.html), and the other option is its final disposition at landfills. From the state of the art the following documents can be quoted: DE 3.426.449 that claims the use of polystyrene foam packaging material which has been thrown away after its use and is suitable for the preparation of surface coating materials and enamel paints. However, this document does not claim at the same conditions of our patent request, which means it does not claim neither the same stages nor materials. Document US2007249741 claims a method using dissolved EPS to obtain a coating material (not paint), therefore it does not interfere with our patent request.

### Solution to the Technical Problem

This patent request solves the problem of EPS waste disposal, by transforming it into a product, more specifically a paint product, with non-obvious properties like glossiness and impermeability to water. The paint is a material that can be used in a wide variety of surfaces such as concrete, asphalt, pavement and plasterboard, among others; therefore, it is a necessary product in homes and all kinds of industries. Additionally, it is known that EPS has the problem of having a large volume (volume/mass ratio), which has the implication of expensive transportation costs and the use of large spaces in landfills, which has the additional consequence of an expensive final disposition.

### DESCRIPTION OF THE INVENTION

This patent claims a process to obtain paints using expanded polystyrene (EPS) waste as a raw material, which is also known in other countries as styrofoam.

This invention is constituted by the following stages after obtaining EPS waste that has been discarded as garbage:

a. Mixing the EPS waste with an organic solvent until reaching a concentration between 20% and 80% p/p. The organic solvent can be chosen among ketones up to 11 saturated carbon atoms, esters up to 11 saturated carbon atoms, substituted benzenes up to 12 saturated carbon atoms, alkanes up to 15 saturated carbon atoms, etc.
a. Decanting impurities of the mixture obtained in stage (a) during 24 to 120 h
b. Collecting the supernatant obtained in stage (b)
c. Dispersing a pigment in the supernatant obtained in stage (c) during 10 to 30 min at a velocity between 1.000 rpm and 2.000 rpm. To do this, a dispersant is used in a concentration between 0.5% and 5.0% of the final composition, an organic solvent in a concentration between 70% and 40% of the final composition, and a pigment in a concentration between 10% and 40% of the final composition in a dispersing machine.
d. Mixing the substance obtained in stage (d) with an organic solvent at a velocity between 300 rpm and 1.000 rpm until reaching the desired concentration.

Due to the process using EPS waste as a raw material, it is necessary to eliminate the solid particles and dust that contaminates it, which is done in stage (b) during the decantation process.

Among the organic solvents used in this invention, but not limited to, we can mention propanone, 2-butanone, 2-pentanone, 3-pentanone, 2-hexanone, 3-hexanone, 2-heptanone, 3-heptanone, 4-hectanone, 2-octanone, 3-octanote, 4-octanone, 2-nonanone, 3-nonanone, 4-nonanone, 5-nonanone, 2-decanone, 3-decanone, 4-decanone, 5-decanone, 2-undecanone, 3-undecanone, 4-undecanone, 5-undecanone, 6-undecanone, 2,4-pentadione, 2,5-hexanodione, 2,4-heptanodione, 2,5-heptanodiones, 2,6-heptanodione, 3,5-heptanodione, 3,6-heptanodione, methyl ethanoate, ethyl ethanoate, propyl ethanoate, isopropyl ethanoate, butyl ethanoate, isobutyl ethanoate, secbutyl ethanoate, tertbutyl ethanoate, pentyl ethanoate, methylbutyl ethanoate, 2-methylbutyl ethanoate, 3-methylbutyl ethanoate, 1,2-dimethylpropyl ethanoate, 2-ethylpropyl ethanoate, hexyl ethanoate, methylpentyl ethanoate, 2-methylpentyl ethanoate, 3-methylpentyl ethanoate, 4-methylpentyl ethanoate, ethylbutyl ethanoate, 2-etylbutyl ethanoate, 3-ethylbutyl ethanoate, methyl propanoate, ethyl propanoate, propyl propanoate, isopropyl propanoate, butyl propanoate, isobutyl propanoate, secbutyl propanoate, tertbutyl propanoate, pentyl propanoate, methylbutyl propanoate, 2-methylbutyl propanoate, 3-methylbutyl propanoate, 1,2-dimethylpropyl propanoate, 2-ethylpropyl propanoate, hexyl propanoate, methylpentyl propanoate, 2-methylpentyl propanoate, 3-methylpenthyl propanoate, 4-methylpentyl propanoate, ethylbutyl propanoate, 2-ethylbutyl propanoate, 3-ethylbutyl propanoate, pentane, 2-methylpentane, 3-methylpentane, hexane, 2-methylhexane, 3-methylhexane, heptane, 2-methylheptane, 3-methylheptane, 4-methylheptane, octane, 2-methyloctane, 3-methyloctane, 4-methyloctane, nonane, 2-methylnonane, 3-methylnonane, 4-methylnonane, 5-methylnonane, decane, 2-methyldecane, 3-methyldecane, 4-methyldecane, 5-methyldecane, 2-ethylpentane, 3-ethylpentane, 2-ethylhexane, 3-ethylhexane, 2-ethylheptane, 3-ethylheptane, 4-ethylheptane, 2-ethyloctane, 3-ethyloctane, 4-ethyloctane, 2-ethylnonane, 3-ethylnonane, 4-ethylnonane, 5-ethylnonane, 2-ethyldecane, 3-ethyldecane, 4-ethyldecane, 5-ethyldecane, benzene, toluene, xylene, trimethylbenzene, ethylbenzene, diethylbenzene, prophylbenzene, diprophylbenzene, chloroform, dichloromethane, gasolines, kerosene, carbon tetrachloride, among others and their mixtures.

Preferably, the organic solvent can be chosen from acetone, xylene, ethylacetate, toluene, among others and their mixtures.

In this invention, the dispersing agent can be chosen among soy lecithin, heavy fraction hydrodesulfure, polyacrilates, nafta, among others.

In this invention, the pigment can be chosen among titanium dioxide (TiO₂), monocyclic cadmium sulfide, lead chromate, iron oxide monohydrate, anhydrous iron oxide, chromic oxide, ferric hexacyanoferrate, among others. Pigments are powder solid substances, and its function is coloring, to give opacity and in other cases to give corrosion resistance or mechanical resistance.

This process is carried out at a temperature between 15 and 30° C.

After the above stages, a paint product is obtained which formula is composed by 10% to 40% of pigment, 70% to 1% of EPS, 0.5% to 5.0% of dispersant and the difference is solvent.

The paint obtained through this invention has the properties of being glossy and waterproof. Commonly, commercial glossy oil has the following properties: 89.2% of water impermeability and a glossiness of about 20.84 BU (on plasterboard), which means that the product obtained through this invention has a better performance as shown in examples 1 and 2. Since this product is made from waste raw material, these properties could not have been inferred from the previous divulged information. ASTM D 523.14 and DIN 18180 were employed to measure glossiness and impermeability.

### EXAMPLES 1-6

Next are shown examples of this invention

### Example 1

a. Mixing 46 g of EPS waste with 42 g of a xylene:ethyl acetate mixture (9:1 ratio) at 25° C.
b. The mixture obtained in stage (a) is left to stand at 25° C. during 48 h until decantation of the impurities.
c. At least 44 g of the supernatant of the mixture obtained in stage (b) were separated from the impurities.
d. 16 g of pigment (TiO₂) were dispersed in 44 g of the stage (c) supernatant which was previously mixed with 1 g of soy lecithin and 20 g of a mixture of xylene:ethyl acetate (9:1 ratio). The dispersion and mixing was performed at 1.100 rpm during 15 min at 25° C. in a BGD750/1 disperser.
e. Once stage (d) was finished, the obtained mixture was mixed with 19 g of a mixture of xylene:ethyl acetate (9:1 ratio). The mixing was performed at 500 rpm during 10 min at 25° C.

Measured properties of the obtained product are as follows:

Water impermeability: 93.9% of water absorption reduction

Glossiness: 19.045 BU (measured on plasterboard)

### Example 2

a. Mixing 46 g of EPS waste with 42 g of xylene at 25° C.
b. The mixture obtained in stage (a) is left to stand at 25° C. during 48 h until decantation of the impurities.
c. At least 44 g of the supernatant of the mixture obtained in stage (b) were separated from the impurities.
d. 16 g of pigment (TiO₂) were dispersed in 44 g of the stage (c) supernatant which was previously mixed with 1 g of soy lecithin and 20 g of a mixture of xylene. The dispersion and mixing was performed at 1.100 rpm during 15 min at 25° C.
e. Once stage (d) was finished, the obtained mixture was mixed with 19 g of xylene. The mixing was performed at 500 rpm during 10 min at 25° C.

Measured properties of the obtained product are as follows:

Water impermeability: 93.9% of water absorption reduction

Glossiness: 22.44 BU (measured on plasterboard)

### Example 3

In another execution of this invention, and only as an example, ethyl acetate was replaced by hexane, employing the following conditions:
a. Mixing 46 g of EPS waste with 42 g of a xylene:hexane mixture (9:1 ratio) at 25° C.
b. The mixture obtained in stage (a) is left to stand at 25° C. during 48 h until decantation of the impurities.
c. At least 44 g of the supernatant of the mixture obtained in stage (b) were separated from the impurities.
d. 16 g of pigment (TiO₂) were dispersed in 44 g of the stage (c) supernatant which was previously mixed with 1 g of soy lecithin and 20 g of a mixture of xylene:hexane (9:1 ratio). The dispersion and mixing was performed at 1.100 rpm during 15 min at 25° C. in a BGD750/1 disperser.
e. Once stage (d) was finished, the obtained mixture was mixed with 19 g of a mixture of xylene:hexane (9:1 ratio). The mixing was performed at 500 rpm during 10 min at 25° C.

Measured properties of the obtained product in this example are similar to the properties obtained to the products of examples 1 and 2.

### Example 4

In another execution of this invention, and only as an example, ethyl acetate was replaced by methanol, employing the following conditions:
a. Mixing 46 g of EPS waste with 42 g of a xylene:methanol mixture (9:1 ratio) at 25° C.
b. The mixture obtained in stage (a) is left to stand at 25° C. during 48 h until decantation of the impurities.
c. At least 44 g of the supernatant of the mixture obtained in stage (b) were separated from the impurities.
d. 16 g of pigment (TiO2) were dispersed in 44 g of the stage (c) supernatant which was previously mixed with 1 g of soy lecithin and 20 g of a mixture of xylene:methanol (9:1 ratio). The dispersion and mixing was performed at 1.100 rpm during 15 min at 25° C. in a BGD750/1 disperser.
e. Once stage (d) was finished, the obtained mixture was mixed with 19 g of a mixture of xylene:methanol (9:1 ratio). The mixing was performed at 500 rpm during 10 min at 25° C.

Measured properties of the obtained product in this example are similar to the properties obtained to the products of examples 1 and 2.

### Example 5

In another execution of this invention, and only as an example, ethyl acetate was replaced by acetone, employing the following conditions:
a. Mixing 46 g of EPS waste with 42 g of a xylene:acetone mixture (9:1 ratio) at 25° C.
b. The mixture obtained in stage (a) is left to stand at 25° C. during 48 h until decantation of the impurities.
c. At least 44 g of the supernatant of the mixture obtained in stage (b) were separated from the impurities.
d. 16 g of pigment (TiO₂) were dispersed in 44 g of the stage (c) supernatant which was previously mixed with 1 g of soy lecithin and 20 g of a mixture of xylene:acetone (9:1 ratio). The dispersion and mixing was performed at 1.100 rpm during 15 min at 25° C. in a BGD750/1 disperser.
e. Once stage (d) was finished, the obtained mixture was mixed with 19 g of a mixture of xylene:acetone (9:1 ratio). The mixing was performed at 500 rpm during 10 min at 25° C.

Measured properties of the obtained product in this example are similar to the properties obtained to the products of examples 1 and 2.

### Example 6

In another execution of this invention, and only as an example, ethyl acetate was replaced by toluene, employing the following conditions:
a. Mixing 46 g of EPS waste with 42 g of a xylene:toluene mixture (9:1 ratio) at 25° C.
b. The mixture obtained in stage (a) is left to stand at 25° C. during 48 h until decantation of the impurities.
c. At least 44 g of the supernatant of the mixture obtained in stage (b) were separated from the impurities.
d. 16 g of pigment (TiO2) were dispersed in 44 g of the stage (c) supernatant which was previously mixed with 1 g of soy lecithin and 20 g of a mixture of xylene:toluene (9:1 ratio). The dispersion and mixing was performed at 1.100 rpm during 15 min at 25° C. in a BGD750/1 disperser.
e. Once stage (d) was finished, the obtained mixture was mixed with 19 g of a mixture of xylene:toluene (9:1 ratio). The mixing was performed at 500 rpm during 10 min at 25° C.

Measured properties of the obtained product in this example are similar to the properties obtained to the products of examples 1 and 2.

1. Process to fabricate paints from expanded polystyrene (EPS) waste, wherein it has the following stages:
a. Mixing the EPS waste with an organic solvent until reaching a mixture with a concentration between 20% and 80% p/p;
b. Decanting impurities of the mixture obtained in stage (a) during 24 to 120 h;
c. Collecting the supernatant obtained in stage (b);
d. Dispersing a pigment in the supernatant obtained in stage (c) during 10 to 30 min at a velocity between 1.000 rpm and 2.000 rpm;
e. Mixing the substance obtained in stage (d) with an organic solvent at a velocity between 300 rpm and 1.000 rpm until reaching the desired concentration.

2. Process to fabricate paints, according to claim 1, wherein the organic solvent in stage (a) is selected among ketones up to 11 saturated carbon atoms, esters up to 11 saturated carbon atoms, substituted benzenes up to 12 saturated carbon atoms, alkanes up to 15 saturated carbon atoms, pure or their mixtures.

3. Process to fabricate paints, according to claim 2, wherein the organic solvents are selected from propanone, 2-butanone, 2-pentanone, 3-pentanone, 2-hexanone, 3-hexanone, 2-heptanone, 3-heptanone, 4-heptanone, 2-octanone, 3-octanote, 4-octanone, 2-nonanone, 3-nonanone, 4-nonanone, 5-nonanone, 2-decanone, 3-decanone, 4-decanone, 5-decanone, 2-undecanone, 3-undecanone, 4-undecanone, 5-undecanone, 6-undecanone, 2,4-pentadione, 2,4-hexanodiona, 2,5-hexanodione, 2,4-heptanodione, 2,5-heptanodiones, 2,6-heptanodione, 3,5-heptanodione, 3,6-heptanodione, methyl ethanoate, ethyl ethanoate, propyl ethanoate, isopropyl ethanoate, butyl ethanoate, isobutyl ethanoate, secbutyl ethanoate, tertbutyl ethanoate, pentyl ethanoate, methylbutyl ethanoate, 2-methylbutyl ethanoate, 3-methylbutyl ethanoate, 1,2-dimethylpropyl ethanoate, 2-ethylpropyl ethanoate, hexyl ethanoate, methylpentyl ethanoate, 2-methylpentyl ethanoate, 3-methylpentyl ethanoate, 4-methylpentyl ethanoate, ethylbutyl ethanoate, 2-etylbutyl ethanoate, 3-ethylbutyl ethanoate, methyl propanoate, ethyl propanoate, propyl propanoate, isopropyl propanoate, butyl propanoate, isobutyl propanoate, secbutyl propanoate, tertbutyl propanoate, pentyl propanoate, methylbutyl propanoate, 2-methylbutyl propanoate, 3-methylbutyl propanoate, 1,2-dimethylpropyl propanoate, 2-ethylpropyl propanoate, hexyl propanoate, methylpentyl propanoate, 2-methylpentyl propanoate, 3-methylpenthyl propanoate, 4-methylpentyl propanoate, ethylbutyl propanoate, 2-ethylbutyl propanoate, 3-ethylbutyl propanoate, pentane, 2-methylpentane, 3-methylpentane, hexane, 2-methylhexane, 3-methylhexane, heptane, 2-methylheptane, 3-methylheptane, 4-methylheptane, octane, 2-methyloctane, 3-methyloctane, 4-methyloctane, nonane, 2-methylnonane, 3-methylnonane, 4-methylnonane, 5-methylnonane, decane, 2-methyldecane, 3-methyldecane, 4-methyldecane, 5-methyldecane, 2-ethylpentane, 3-ethylpentane, 2-ethylhexane, 3-ethylhexane, 2-ethylheptane, 3-ethylheptane, 4-ethylheptane, 2-ethyloctane, 3-ethyloctane, 4-ethyloctane, 2-ethylnonane, 3-ethylnonane, 4-ethylnonane, 5-ethylnonane, 2-ethyldecane, 3-ethyldecane, 4-ethyldecane, 5-ethyldecane, benzene, toluene, xylene, trimethylbenzene, ethylbenzene, diethylbenzene, prophylbenzene, diprophylbenzene, chloroform, dichloromethane, gasolines, kerosene, carbon tetrachloride, among others and their mixtures.

4. Process to fabricate paints, according to claim 3, wherein the organic solvents are selected from acetone, xylene, ethyl acetate, toluene, hexane, and their mixtures.

5. Process to fabricate paints, according to claim 1, wherein during the dispersion of stage (d) a dispersing agent is added in a concentration between 0.5% and 5.0% of the final composition, an organic solvent in a concentration between 70% and 40% of the final composition, and a pigment in a concentration between 10% and 40% of the final composition in a dispersing machine.

6. Process to fabricate paints, according to claim 1, wherein the dispersing agent is selected from soy lecithin, heavy fraction hydrodesulfure, polyacrilates, nafta.

7. Process to fabricate paints, according to claim 1, wherein the pigment is selected from titanium dioxide (TiO₂), monocyclic cadmium sulfide, lead chromate, iron oxide monohydrate, anhydrous iron oxide, chromic oxide, ferric hexacyanoferrate.

8. Process to fabricate paints, according to claim 1, wherein the process is performed at a temperature between 15 and 30° C.

9. Paint obtained through the process in claim 1, wherein the paint has a pigment concentration between 10% to 40%, EPS between 70% to 1%, dispersant between 0.5% to 5.0%, and the difference is solvent.
